(19) United States
(12) Patent Application Publication
(10) Pub. No.: US 2006/0022060 A1
(43) Pub. Date: Feb. 2, 2006

(54) Sequence of skin care application indicia and method

(76) Inventor: Denise Forte-Pathroff, Bismarck, ND (US)

Correspondence Address: UNITED STATES SURGICAL,;A DIVISION OF TYCO HEALTHCARE GROUP LP, 150 GLOVER AVENUE, NORWALK, CT, 06856, US

(21) Appl. No.: 11/186,677

(22) Filed: Jul. 20, 2005

Related U.S. Application Data
(63) Continuation of application No. 10/047,334, filed on Jan. 14, 2002, now abandoned.

(51) Int. Cl. G06K 19/06; G06K 7/00; G06K 19/00

(52) U.S. Cl. 235/494; 235/487; 235/486

(57) ABSTRACT

A coding system for use in conjunction with a series of products is disclosed. The coding system includes indicia indicating to a user of the series of sequentially applied products a time and a sequence of use of the series of products is provided. The coding system includes time indicia disposed on the surface of each product of the series of products. The time indicia indicates to the user of the product a time of day for using the particular product of the series of products. This enables the user to select a group of products having a common time indicia from the series of products. The coding system further includes sequence indicia disposed on the surface of each product of the series of products The sequence indicia indicates to the user an order of using each product of said series of products.

### CROSS-REFERENCE TO RELATED APPLICATIONS

This application is a continuation of co-pending U.S. application Ser. No. 10/047,334 filed on Jan. 14, 2002 all of which is incorporated herein by reference in its entirety.

### BACKGROUND

1. Technical Field

The present disclosure relates to a sequence of skin care application and, more particularly to a coding system for use on a skin care product system that matches a specific application time with a specific application sequence. In addition, the present disclosure relates to a skin care product application method and, more particularly to a method for applying a particular skin care product of a skin care system at a specific time and in a specific order.

2. Background of Related Art

In the past, it has been the conventional practice to supply topical skin care products in bottles containing labels adhered to the surface of the bottle which provide type written instructions as to the products use or in the alternative the skin care product is accompanied by a type written instructional sheet providing the user with instructions as to the products use. As is customary, the label or instruction sheet contains information specifying the time of application of the product, the steps in preparing the skin for application of the product, and the order of application of a particular skin care product when combined with several other skin care products.

However, problems and difficulties have been encountered when using the type written labels and instructions sheets commonly provided with skin care products. For example, the written text is generally of a small type and difficult to read with the naked eye. This problem is only exacerbated for individuals who are far sighted or with the elderly who more typically require corrective lenses in order to see clearly. Accordingly, such individuals my not readily be able to read or follow the instructions printed on the label or on the instruction sheet. In addition, the often complex instructions indicated on the label or instruction sheets, regarding application times and sequences, may not be readily understood or read by a mentally impaired person.

Therefore, the need exists for providing a coding system and sequence of skin care application indicia indicative of daily application times and application sequences for the individual skin care products. Such a coding system must be simple and complete so that sight and/or mentally impaired persons can properly apply the proper skin care product in the proper sequence. In addition, the need exists for a skin care application method for applying a particular skin care product, at a specific time and in a specific order.

### SUMMARY

In accordance with the present disclosure, a coding system for use in conjunction with a series of products, the coding system having indicia indicating to a user of the series of sequentially applied products a time and a sequence of use of the series of products is provided. The coding system includes time indicia disposed on the surface of each product of the series of products. The time indicia indicates to the user of the product a time of day for using the particular product of the series of products. This enables the user to select a group of products having a common time indicia from the series of products, thus allowing the user to benefit from the use of these common products at the appropriate time. The coding system further includes sequence indicia disposed on the surface of each product of the series of products. The sequence indicia indicates to the user an order of using each product of said series of products. The sequence indicia enables the user to obtain the most benefits from using the group of selected products in a predetermined order.

Preferably, the time indicia includes at least a portion of a solar character enabling the user of the series of products to select a first group of products from the series of products which are to be used during the day. Preferably, the time indicia also includes at least a portion of a lunar character enabling the user of the series of products to select a second group of products from the series of products which are to be used at night.

It is preferred that the sequence indicia include a series of ascending numerical characters. The ascending numerical characters instruct the user as to the proper order of using the selected products. Preferably, the products of each of the first and second group of products is used in ascending numerical order. Alternatively, ascending alphabetical characters are also contemplated.

In a preferred embodiment, the coding system is disposed on a series of labels and the series of labels adhered to the surface of the container retaining a respective product from the series of products.

In addition, in accordance with the present disclosure a method of determining a proper time and a proper sequence of the use of a series of products is disclosed. According to the presently disclosed method, a time indicia is assigned to each product of the series of products. The time indicia indicates to a user of the series of products a time of day for using a particular product from the series. A sequence indicia is assigned to each product of the series of products. The sequence indicia indicates to the user of the series of products an order of using a particular group of products selected from the series of products. A user the determines the time of day it is and correlates the time indicia of each product from the series with the time of day it is. The user then selects a group of products from the series of products each having a common time indicia relating to the determined time of day. The user then uses the selected group of products in the order of the sequential indicia associated with each product.

Preferably, the user selects a morning group of products from said series of products. The morning group of products having a solar character associated therewith as the time indicia which indicates to the user that the product is to be used in the morning. The user then uses the morning group of products in ascending numerical order based on numerical indicia associated therewith which numerical indicia indicates to the user the order for applying the particular products of the morning group of products.

In addition, the method preferably includes the user selecting an evening group of products from said series of products. The evening group of products having a lunar character associated therewith as the time indicia which indicates to the user that the product is to be used in the evening.

### DETAILED DESCRIPTION OF THE DRAWINGS

The accompanying drawings, which are incorporated in and constitute a part of this specification, illustrate embodiments of the disclosure and, together with a general description of the disclosure given above, and the detailed description of preferred embodiments given below, serve to explain the principles of the disclosure.

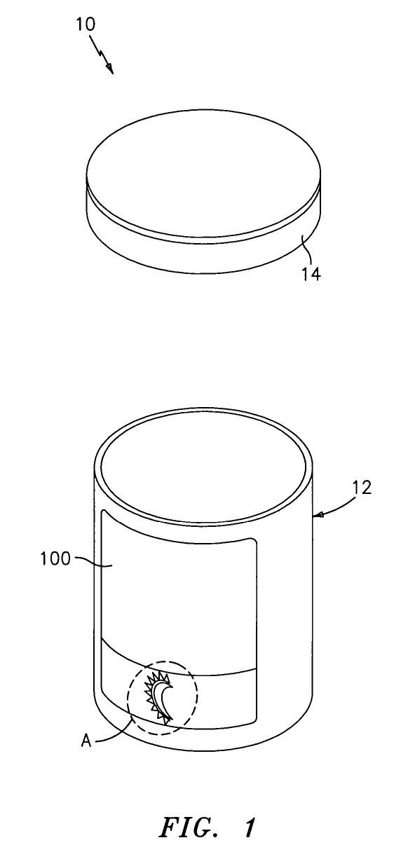

FIG. 1 is a front perspective view of a container for holding a quantity of a skin care product and which includes a coding system having a sequence of application indicia in accordance with the present disclosure;

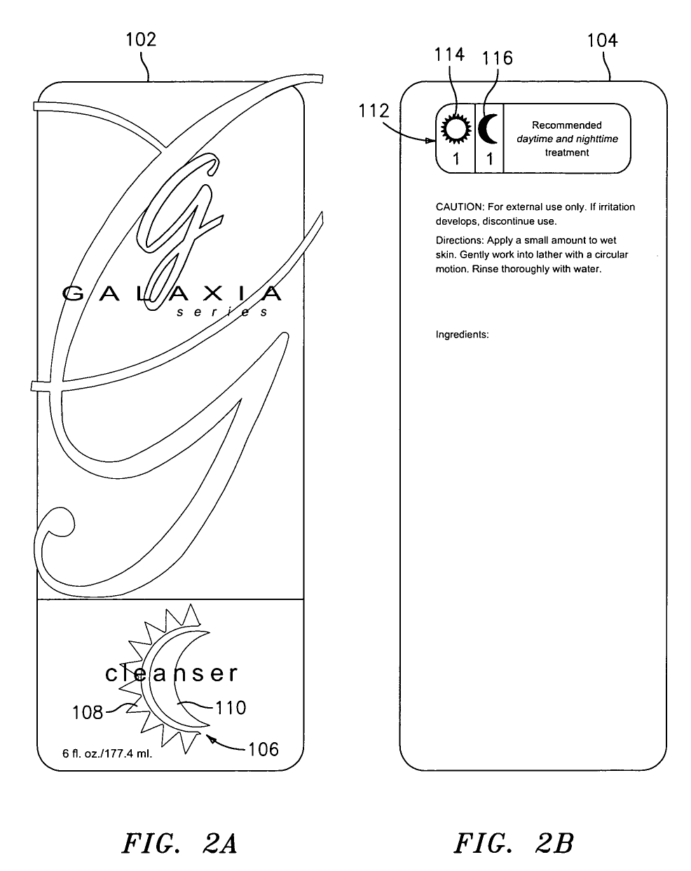

FIG. 2A shows a first label, in accordance with the present coding system having a sequence of application indicia, to be applied to a first skin care product;

FIG. 2B shows a second label, in accordance with the present coding system having a sequence of application indicia, to be applied to the first skin care product;

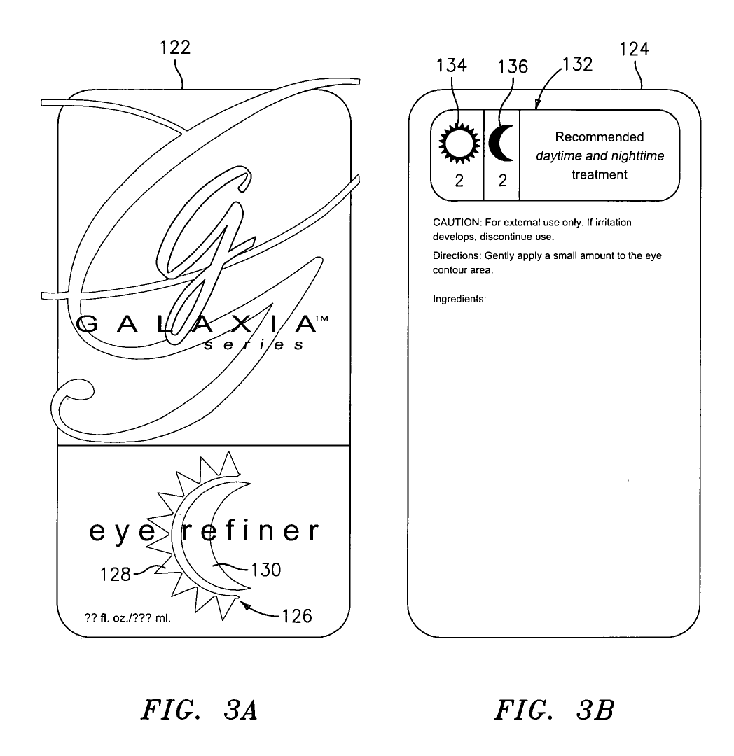

FIG. 3A shows a first label, in accordance with the present coding system having a sequence of application indicia, to be applied to a second skin care product;

FIG. 3B shows a second label, in accordance with the present coding system having a sequence of application indicia, to be applied to the second skin care product;

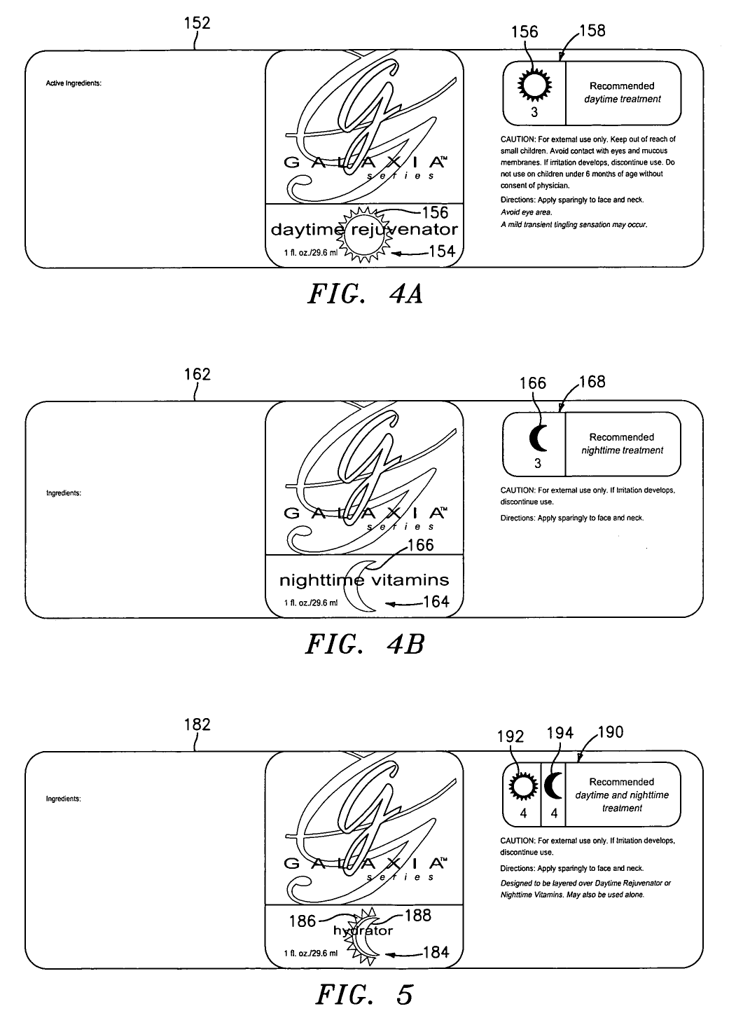

FIG. 4A shows a label, in accordance with the present coding system having a sequence of application indicia, to be applied to a third skin care product;

FIG. 4B shows a label, in accordance with the present coding system having a sequence of application indicia, to be applied to a fourth skin care product;

FIG. 5 shows a label, in accordance with the present coding system having a sequence of application indicia, to be applied to a fifth skin care product;

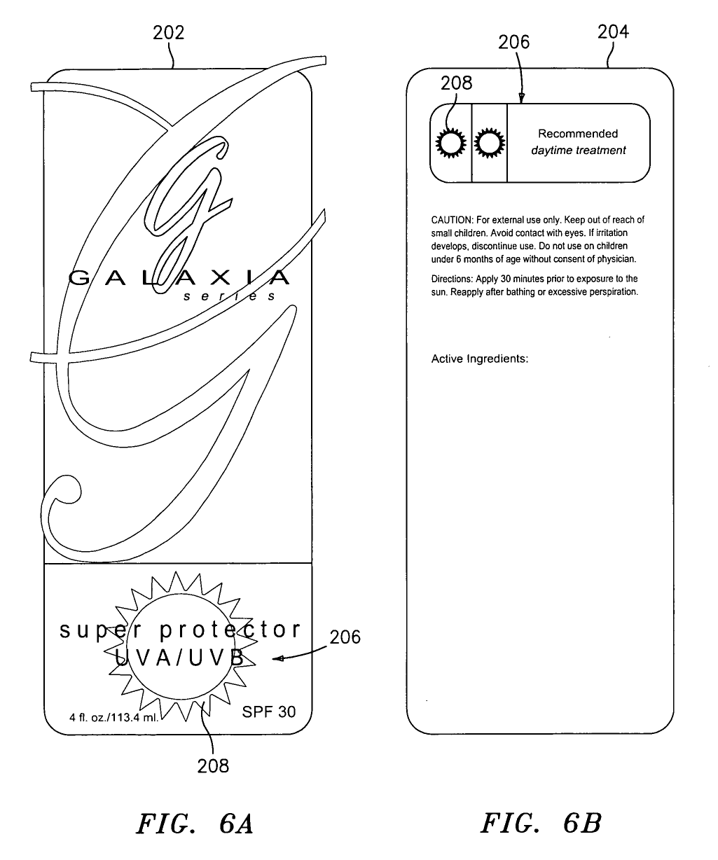

FIG. 6A shows a first label, in accordance with the present coding system having a sequence of application indicia, to be applied to a sixth skin care product; and

FIG. 6B shows a second label, in accordance with the present coding system having a sequence of application indicia, to be applied to the sixth skin care product.

### DETAILED DESCRIPTION OF PREFERRED EMBODIMENTS

Preferred embodiments of the presently disclosed coding system having a sequence of application indicia will now be described in detail with reference to the drawing figures wherein like reference numerals identify similar or identical elements. While the presently disclosed coding system having a sequence of application indicia will be described in connection with printed labels which are adhered to the surface of a container (i.e., package, box, plastic or glass bottle, jar, tub, insert, removable tags, pamphlets, etc) of the particular skin care product, it is envisioned that the coding system and skin care application indicia can be printed directly onto the surface of package.

Turning initially to FIG. 1, a container for storing a skin care product incorporating the coding system having a sequence of application indicia in accordance with the present disclosure is generally shown as 10. Container 10 includes a cylindrical retaining portion 12 configured and adapted for retaining a skin care product (not shown) therein and a cap 14 configured and adapted to close an open end of retaining portion 12 so that the medication is securely stored therein. Cap 14 may be coupled to the open end of retaining portion 12 by any suitable means which may take the form of a snap-lock engagement, a threaded engagement, a flip-top engagement or a socket closure.

As will be discussed in greater detail below, container 10 includes a label 100, in accordance with the present disclosure, adhered to the outer surface thereof. Label 100 includes time indicia (denoted by the area “A” in FIG. 1) which instructs the user as to the preferred time of application or use of the skin care product as well as to the order of application or use of the skin care product.

Turning now to FIGS. 2A and 2B, a first and a second label 102 and 104, respectively, for applying to a container of a first skin care product (i.e., a cleanser), are illustrated. First label 102 of the cleanser includes indicia 106 in the form of a solar character 108 and a lunar character 110 indicating to the user the preferred times for applying or using the cleanser. Solar character 108 indicates to the user that the cleanser must be applied or used in the morning or during the day. Lunar character 110 indicates to the user that the cleanser must be applied or used in the evening or at night.

Concomitantly, second label 104 includes indicia 112 in the form of a solar character 114 having the numeral “1” associated therewith and the form of a lunar character 116 having the numeral “1” also associated therewith. Solar character 114 together with numeral “1” associated therewith, indicates to the user that the cleanser is the first skin care product applied or used in the morning. Meanwhile, lunar character 116 together with numeral “1” associated therewith, indicates to the user that the cleanser is the first skin care product applied or used in the evening. While the numeral “1” has been disclosed as being associated with indicia 112 of second label 104, it is envisioned that numeral “1” can also be associated with indicia 106 of label 102.

Turning now to FIGS. 3A and 3B, a first and a second label 122 and 124, respectively, for applying to a container of a second skin care product (i.e., an eye refiner), are illustrated. First label 122 of the eye refiner includes indicia 126 in the form of a solar character 128 and a lunar character 130 indicating to the user the preferred times for applying or using the eye refiner. Solar character 128 indicates to the user that the eye refiner must be applied or used in the morning or during the day. Lunar character 130 indicates to the user that the eye refiner must be applied or used in the evening or at night.

Second label 124 includes indicia 132 in the form of a solar character 134 having the numeral “2” associated therewith and the form of a lunar character 136 having the numeral “2” also associated therewith. Solar character 134 together with numeral “2” associated therewith, indicates to the user that the eye refiner is the second skin care product applied or used in the morning, after application of the cleanser. Meanwhile, lunar character 136 together with numeral “2” associated therewith, indicates to the user that the eye refiner is the second skin care product applied or used in the evening, after application of the cleanser. While the numeral “2” has been disclosed as being associated with indicia 132 of second label 124, it is envisioned that numeral “2” can also be associated with indicia 126 of label 122.

Turning now to FIGS. 4A and 4B, a label 152 for applying to a container of a third skin care product (i.e., a rejuvenator) and a label 162 for applying to a container of a fourth skin care product (i.e., a vitamin package), are illustrated. Label 152 for the rejuvenator includes first indicia 154 in the form of a solar character 156 indicating to the user the preferred time of day for application or use of the rejuvenator. Solar character 156 indicates to the user that the rejuvenator must be applied or used in the morning or during the day. Concomitantly, label 152 includes second indicia 158 also in the form of solar character 156 having the numeral “3” associated therewith. Solar character 156 together with numeral “3” associated therewith, indicates to the user that the rejuvenator is the third skin care product applied or used in the morning. While the numeral “3” has been disclosed as being associated with second indicia 158 of label 152, it is envisioned that numeral “3” can also be associated with first indicia 154 of label 152.

Meanwhile, label 162 for the vitamin package includes first indicia 164 in the form of a lunar character 166 indicating to the user the preferred time of day for application or use of the vitamin package. Lunar character 166 indicates to the user that the vitamin package must be applied or used in the evening or at night. Concomitantly, label 162 includes second indicia 168 also in the form of lunar character 166 having the numeral “3” also associated therewith. Lunar character 166 together with numeral “3” associated therewith, indicates to the user that the vitamin package is the third skin care product applied or used in the evening. While the numeral “3” has been disclosed as being associated with second indicia 168 of label 162, it is envisioned that numeral “3” can also be associated with first indicia 164 of label 162.

Turning now to FIG. 5, a label 182, for applying to a container of a fifth skin care product (i.e., a hydrator), is illustrated. Label 182 of the hydrator includes indicia 184 in the form of a solar character 186 and a lunar character 188 indicating to the user the preferred times for applying or using the hydrator. Solar character 186 indicates to the user that the hydrator must be applied or used in the morning or during the day while lunar character 188 indicates to the user that the hydrator must be applied or used in the evening or at night.

Concomitantly, label 182 includes indicia 190 in the form of a solar character 192 having the numeral “4” associated therewith and the form of a lunar character 194 having the numeral “4” also associated therewith. Solar character 192 together with numeral “4” associated therewith, indicates to the user that the hydrator is the fourth skin care product applied or used in the morning. Meanwhile, lunar character 194 together with numeral “4” associated therewith, indicates to the user that the hydrator is the fourth skin care product applied or used in the evening. While the numeral “4” has been disclosed as being associated with indicia 190 of label 182, it is envisioned that numeral “4” can also be associated with indicia 184 of label 182.

Turning now to FIGS. 6A and 6B, a first and a second label 202 and 204, respectively, for applying to a container of a sixth skin care product (i.e., a UVA/UVB protector), are illustrated. Both first label 202 and second label 204 of the protector includes indicia 206 in the form of a solar character 208 indicating to the user the preferred time for applying or using the protector. Solar character 208 indicates to the user that the protector must be applied or used in the morning or during the day.

While a solar character has been disclosed as being indicative of application or use of a particular skin care product in the morning or during the day, it is envisioned that any symbol can be used to indicate morning or day, such as for example, the term “AM.” Additionally, while a lunar character has been disclosed as being indicative of application or use of a particular skin care product at night or in the evening, it is envisioned that any symbol can be used to indicate evening or night, such as, for example, the term “PM.” Moreover, while arabic numerals “1-4” have been disclosed as being indicative of the order of application of the skin care product, it is envisioned that any indicia can be used to denote the order of application, such as, for example, roman numerals, a number of dots, braille numerals, etc.

Assuming that a user has all of the skin care products disclosed herein, namely, a cleanser having labels 104 and 104 adhered thereto, an eye refiner having labels 122 and 124 adhered thereto, a rejuvenator having label 152 adhered thereto, a vitamin package having label 162 adhered thereto, a hydrator having label 182 adhered thereto and a protector having labels 202 and 204 adhered thereto, a preferred method of use of the coding system in accordance with the present disclosure will now be described with reference to FIGS. 2A-6B. While the method of using the coding system and skin care application indicia in accordance with the present disclosure will be described with reference to the above described products, it is envisioned that the coding system and skin care application indicia can be used in conjunction with other products as well.

According to the preferred method of using the present coding system, a user of the skin care product first determines if is morning/day or evening/night. If the user determines that it is the morning or day time, the user selects all of the skin care products having a solar character associated therewith, namely, cleanser including labels 102 and 104 having solar characters 108 and 114, respectively, eye refiner including labels 122 and 124 having solar characters 128 and 134, respectively, rejuvenator including label 152 having solar character 156, hydrator including label 182 having solar characters 186 and 192, and protector including labels 202 and 204 having solar character 208.

With all of the skin care products having a solar character associated therewith selected, the user arranges the selected skin care products in ascending numerical order based on the numerals “1-4” associated with each individual skin care product. The user then applies the skin care products, in the morning or during the day, sequentially, in ascending numerical order. In the present instance, the user first applies the cleanser having numeral “1” associated therewith, second, the user applies the eye refiner having numeral “2” associated therewith, third, the user applies the rejuvenator having numeral “3” associated therewith, and fourth, the user applies the hydrator having numeral “4” associated therewith. Optionally, the user can apply the protector, not having any numeral associated therewith, at any time during the day.

If the user determines that it is the evening or night time, the user selects all of the skin care products having a lunar character associated therewith, namely, cleanser including labels 102 and 104 having lunar characters 110 and 116, respectively, eye refiner including labels 122 and 124 having lunar characters 130 and 136, respectively, vitamin product including label 152 having lunar character 166, and hydrator including label 182 having lunar characters 188 and 194.

With all of the skin care products having a lunar character associated therewith selected, the user arranges the selected skin care products in ascending numerical order based on the numerals “1-4” associated with each individual skin care product. The user then applies the following skin care products in the evening or at night, sequentially, in ascending numerical order. In the present instance, the user first applies the cleanser having numeral “1” associated therewith, second, the user applies the eye refiner having numeral “2” associated therewith, third, the user applies the vitamin package having numeral “3” associated therewith, and fourth, the user applies the hydrator having numeral “4” associated therewith.

While the above described coding system and skin care application indicia and method have been described in connection with skin care products, it is envisioned that the above described coding system and method can be used in connection with various other products such as for example cosmetic products, hair care products, medications and the like. It will be understood that various modifications may be made to the embodiments of the presently disclosed coding system and steps of the method. Therefore, the above description should not be construed as limiting, but merely as exemplifications of preferred embodiments. Those skilled in the art will envision other modifications within the scope and spirit of the present disclosure.

1-17. (canceled)

18. A coding system for use in combination with a series of sequentially applied products, the coding system comprising:
a plurality of separate and discrete containers for storing a quantity of an applicable product therein;
time indicium disposed on a surface of each of said containers, wherein a group of containers having a common time indicium is selectable from the plurality of containers, and wherein said time indicium indicates to a user of said applicable products a time of day for using said products having the common time indicium; and
sequence indicium disposed on a surface of each of said containers, wherein said sequence indicium indicates to the user of said applicable products a sequential order for using said products having the common time indicium.

19. The coding system according to claim 18, wherein said time indicium includes a solar character enabling said user of said applicable products to select a first group of containers from said plurality of containers which are to be used during the day, and wherein said time indicia includes a lunar character enabling said user of said applicable products to select a second group of containers from said plurality of containers which are to be used at night.

20. The coding system according to claim 19, wherein said sequence indicium includes a series of ascending numerical characters, wherein said ascending numerical characters instruct said user to use said applicable products of each of said first and second group of containers in an ascending numerical order.

21. The coding system according to claim 20, wherein at least one of said time and sequence indicium is disposed on a series of labels, wherein said labels are disposed on the surface of the containers.

22. The coding system according to claim 21, wherein each of said container defines a product retaining portion and includes a cap configured and adapted to close an open end of said container.

23. A label system for application to each container of a series of separate and discrete containers, wherein each container stores a quantity of an applicable product therein, the label comprising:
time indicium disposed on a surface of each of said containers, wherein a group of containers having a common time indicium is selectable from the plurality of containers, and wherein said time indicium indicates to a user of said applicable products a time of day for using said products having the common time indicium; and
sequence indicium disposed on a surface of each of said containers, wherein said sequence indicium indicates to the user of said applicable products a sequential order for using said products having the common time indicium.

24. The label system according to claim 23, wherein said time indicium includes a solar character enabling said user of said applicable products to select a first group of containers from said plurality of containers which are to be used during the day, and wherein said time indicia includes a lunar character enabling said user of said applicable products to select a second group of containers from said plurality of containers which are to be used at night.

25. The label system according to claim 24, wherein said sequence indicium includes a series of ascending numerical characters, wherein said ascending numerical characters instruct said user to use said applicable products of each of said first and second group of containers in an ascending numerical order.

26. The label system according to claim 25, wherein at least one of the time and sequence indium is applied directly onto a surface of each container.

27. The label system according to claim 25, wherein said time and sequence indicium are applied to a first surface of a label, and wherein said labels are affixed onto a surface of each container.

28. A method of using a plurality of applicable products, comprising the steps of:
providing a plurality of applicable products each stored in a respective separate and discrete container, each container includes:
time indicium disposed on a surface thereof, wherein said time indicium indicates to a user of said applicable products a time of day for using said products having the common time indicium; and
sequence indicium disposed on a surface of each of said containers, wherein said sequence indicium indicates to the user of said applicable products a sequential order for using said products having the common time indicium;
selecting a group of containers having a common time indicium from the plurality of containers; and
using said applicable products from said selected group of containers having the common time indicium in an order corresponding to said sequence indicium.

29. The method according to claim 28, wherein said time indicium includes a solar character enabling said user of said applicable products to select a first group of containers from said plurality of containers which are to be used during the day, and wherein said time indicia includes a lunar character enabling said user of said applicable products to select a second group of containers from said plurality of containers which are to be used at night.

30. The method according to claim 29, wherein said sequence indicium includes a series of ascending numerical characters, wherein said ascending numerical characters instruct said user to use said applicable products of each of said first and second group of containers in an ascending numerical order.

31. The method according to claim 30, wherein at least one of said time and sequence indicium is disposed on a series of labels, wherein said labels are disposed on the surface of the containers.

32. A method of providing a plurality of applicable products for use at a specific time and in a specific sequence, the method comprising the steps of:
providing a plurality of separate and discrete containers each configured and adapted to store a quantity of an applicable product therein;
assigning a time indicium to each container, wherein said time indicium indicates to a user of said applicable products a time of day for using each specific product of said plurality of products, wherein a group of applicable products having a common time indicium is selectable from the said plurality of products; and
assigning a sequence indicium to each container, wherein said sequence indicium indicates to said user of said applicable products an order of using said applicable products from a group of selected products.
